(19) United States
(12) Patent Application Publication
(10) Pub. No.: US 2023/0073669 A1
(43) Pub. Date: Mar. 9, 2023

(54) OPTIMISING A NEURAL NETWORK

(71) Applicant: Arm Limited, Cambridge (GB)

(72) Inventor: Mark John O'CONNOR, Cambridge (GB)

(21) Appl. No.: 18/055,192

(22) Filed: Nov. 14, 2022

Related U.S. Application Data
(63) Continuation of application No. PCT/GB2021/051190, filed on May 18, 2021.

(30) Foreign Application Priority Data
May 18, 2020 (GB) 2007329.2

(51) Int. Cl. G06N 3/08; G06N 3/04

(52) U.S. Cl. CPC G06N 3/082; G06N 3/0454

(57) ABSTRACT

A computer-implemented method of optimising a student neural network (SNN), based on a previously-trained neural network (PTNN) trained on first data (FD) using a first processing system (FPS). The method includes using a second processing system (SPS) to generate reference output data (ROD) from the previously-trained neural network (PTNN) in response to inputting second data (SD) to the previously-trained neural network (PTNN). The method also includes optimising a student neural network (SNN) for processing the second data (SD) with the second processing system (SPS), by using the second processing system (SPS) to adjust a plurality of parameters of the student neural network (SNN) such that a difference (DIFF) between the reference output data (ROD), and second output data (SOD) generated by the student neural network (SNN) in response to inputting the second data (SD) to the student neural network (SNN), satisfies a stopping criterion.

### CROSS-REFERENCE TO RELATED APPLICATIONS

This application is the U.S. national stage application filed pursuant to 35 U.S.C. 365(c) and 120 as a continuation of International Patent Application No. PCT/GB2021/051190, filed May 18, 2021, which application claims priority to United Kingdom Patent Application No. 2007329.2, filed May 18, 2020, which applications are incorporated herein by reference in their entireties.

### TECHNICAL FIELD

The present disclosure relates to a computer-implemented method of optimising a neural network. A related computer program product and system are also disclosed.

### BACKGROUND

Neural networks are employed in a wide range of applications such as image classification, speech recognition, character recognition, image analysis, natural language processing, gesture recognition and so forth. Many different types of neural network such as Convolutional Neural Networks “CNN”, Recurrent Neural Networks “RNN”, Generative Adversarial Networks “GAN”, and Autoencoders have been developed and tailored to such applications.

A feature common to neural networks is that they include multiple “neurons”, which are the basic unit of a neural network. A neuron has one or more inputs and generates an output based on the input(s). The value of data applied to each input(s) is weighted, summed, and applied to an “activation function” that sums the weighted inputs in order to determine the output of the neuron. The activation function also has a “bias” that controls the output of the neuron by providing a threshold to then neuron's activation. The neurons are typically arranged in layers, which may include an input layer, an output layer, and one or more hidden layers arranged between the input layer and the output layer. The neurons are connected to one another by the weights that are applied to the neuron inputs. Connections between the neurons may be between neurons in the same layer in the neural network, or between neurons in different layers. The weights determine the strength of each connection in the network and thus control the flow of information between the input layer and the output layer of the neural network. The weights, the biases, and the neuron connections are examples of “trainable parameters” of the neural network that are “learnt”, or in other words, capable of being trained, during a neural network “training” process. Another example of a trainable parameter of a neural network, found particularly in neural networks that include a normalization layer, is the (batch) normalization parameter(s). During training, the (batch) normalization parameter(s) are learnt from the statistics of data flowing through the normalization layer.

A neural network also includes “hyperparameters” that are used to control the neural network training process. Depending on the type of neural network concerned, the hyperparameters may for example include one or more of: a learning rate, a decay rate, momentum, a learning schedule and a batch size. The learning rate controls the magnitude of the weight adjustments that are made during training. The batch size is defined herein as the number of data points used to train a neural network model in each iteration. Together, the hyperparameters and the trainable parameters of the neural network are defined herein as the “parameters” of the neural network.

The process of training a neural network includes adjusting the weights that connect the neurons in the neural network, as well as adjusting the biases of activation functions controlling the outputs of the neurons. There are two main approaches to training: supervised learning and unsupervised learning. Supervised learning involves providing a neural network with input data and corresponding output data. During supervised learning the weights and the biases are automatically adjusted such that when presented with the input data, the neural network accurately provides the corresponding output data. The input data is said to be “labelled” or “classified” with the corresponding output data. In unsupervised learning the neural network decides itself how to classify or generate another type of prediction from un-labelled input data based on common features in the input data by likewise automatically adjusting the weights, and the biases. Semi-supervised learning is another approach to training wherein a neural network is input with a combination of labelled and un-labelled data. Typically the input data includes a minor portion of labelled data. During training the weights and biases of the neural network are automatically adjusted using guidance from the labelled data.

Whichever training process is used, training a neural network typically involves inputting a large amount of data, and making numerous of iterations of adjustments to the neural network parameters in order to ensure that the trained neural network provides an accurate output. As may be appreciated, significant processing resources are typically required in order to perform such training. Dedicated neural processors, also known as neural network accelerators, AI accelerators, and Tensor Processing Units “TPU” are often employed in contrast to a general purpose Central Processing Units “CPU” or Graphics Processing Units “GPU” in order to accelerate the process of training a neural network. Training therefore typically employs a centralized approach wherein cloud-based or mainframe-based neural processors are used to train a neural network. By contrast, after the training process has been completed, the processing requirements of neural networks are significantly diminished. This allows a trained neural network to be deployed, for example to a device, and used in systems having significantly less processing capability.

However, there remains a need to provide improved neural networks.

### SUMMARY

According to a first aspect of the present disclosure, there is provided a computer-implemented method of optimising a student neural network, based on a previously-trained neural network trained on first data using a first processing system. The method includes: using a second processing system to generate reference output data from the previously-trained neural network in response to inputting second data to the previously-trained neural network; and optimising a student neural network for processing the second data with the second processing system, by using the second processing system to adjust a plurality of parameters of the student neural network such that a difference between the reference output data, and second output data generated by the student neural network in response to inputting the second data to the student neural network, satisfies a stopping criterion.

According to a second aspect of the present disclosure the method includes: identifying a subset of second processing system input data to use as the second data. Second processing system input data is included in the subset if the sampled second processing system input data increases a diversity metric of the subset.

According to a third aspect of the present disclosure the method includes: optimising the student neural network by reducing a precision of its weights, and/or removing neurons and/or connections defined by its weights.

According to a fourth aspect of the present disclosure the method includes: generating test output data from the student neural network in response to test input data. The test input data has corresponding expected output data that is expected from the student neural network. The optimising of the student neural network is constrained such that a difference between the generated test output data, and the expected output data, is less than a second predetermined value.

A computer program product and a system are provided in accordance with other aspects of the disclosure. The functionality disclosed in relation to computer-implemented method may also be implemented in the computer program product, and in the system in a corresponding manner.

Further features and advantages of the disclosure will become apparent from the following description of preferred implementations of the disclosure, given by way of example only, which is made with reference to the accompanying drawings.

### BRIEF DESCRIPTION OF THE DRAWINGS

FIG. 1 is a schematic diagram illustrating an example neural network.

FIG. 2 is a schematic diagram illustrating an example neuron.

FIG. 3 is a schematic diagram that includes a second processing system SPS for optimising a student neural network SNN in accordance with some aspects of the disclosure.

FIG. 4 is a flowchart illustrating a method MET of optimising a student neural network SNN in accordance with some aspects of the disclosure.

FIG. 5 is a flowchart illustrating a method of providing second data SD from second processing system input data SPSID in accordance with some aspects of the disclosure.

FIG. 6 is a schematic diagram that includes a second processing system SPS for optimising a student neural network SNN that includes the constraining of the optimising of the student neural network SNN in accordance with some aspects of the disclosure.

FIG. 7 is a flowchart illustrating a method of optimising a student neural network SNN that includes the constraining of the optimising of the student neural network SNN in accordance with some aspects of the disclosure.

FIG. 8 illustrates a system SY for optimising a student neural network SNN that includes a processor in the form of second processing system SPS, and a memory MEM.

### DETAILED DESCRIPTION

Examples of the present application are provided with reference to the following description and the figures. In this description, for the purposes of explanation, numerous specific details of certain examples are set forth. Reference in the specification to “an example”, “an implementation” or similar language means that a feature, structure, or characteristic described in connection with the example is included in at least that one example. It is also to be appreciated that features described in relation to one example may also be used in another example and that all features are not necessarily duplicated for the sake of brevity. For instance, features described in relation to the computer-implemented method may be used in the computer program product and in the system in a corresponding manner.

In the present disclosure, reference is made to examples of a neural network in the form of a Deep Feed Forward neural network. It is however to be appreciated that the disclosed method is not limited to use with this particular type of neural network, and that it may be used with other types neural networks, such as for example a CNN, a RNN, a GAN, an Autoencoder, and so forth. Reference is also made to operations in which the neural network processes input data in the form of image data, and uses this to generate output data in the form of a predicted classification. It is to be appreciated that these example operations serve for the purpose of explanation, and that the disclosed method is not limited to use in classifying image data. The disclosed method may be used to generate predictions in general, and the method may process other forms of input data such as audio data, motion data, financial data, and so forth.

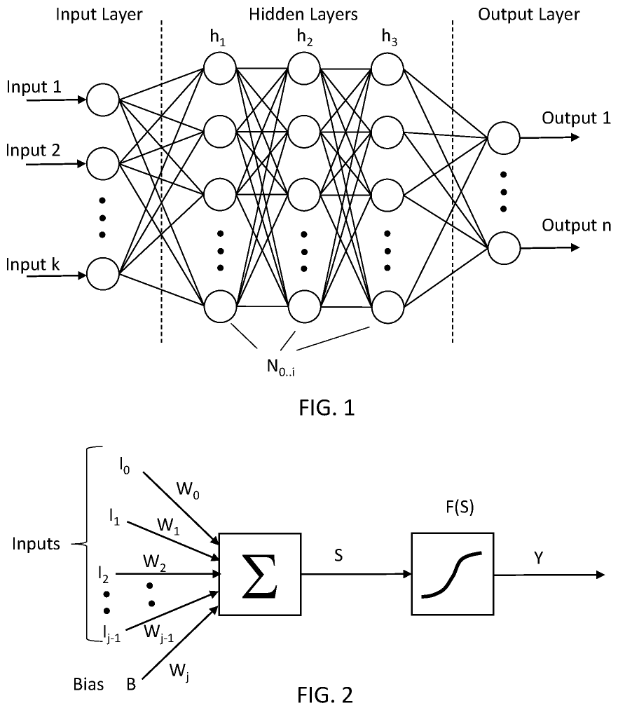

FIG. 1 illustrates a schematic diagram of an example neural network. The example neural network in FIG. 1 is a Deep Feed Forward neural network that includes neurons arranged in an input layer, three hidden layers h₁-h₃ and an output layer. The example neural network in FIG. 1 receives input data in the form of numeric or binary input values at the inputs, Input₁-Inputₖ, of neurons in its input layer, processes the input values by means of the neurons in its hidden layers, h₁-h₃, and generates output data at the outputs, Outputs_{1 . . . n}, of neurons in its output layer. The number of neurons in the input layer corresponds to the number of features that the network uses to make its predictions. The input data may for instance represent image data, or speech data and so forth. Each neuron in the input layer represents a portion of the input data, such as for example a pixel of an image that is provided as the input data. The number of neurons in the output layer depends on the number of predictions the neural network is programmed to perform. For regression tasks such as the prediction of a currency exchange rate this may be a single neuron. For a classification task such as classifying images as one of cat, dog, horse, etc. there is typically one neuron per classification class in the output layer. The number of neurons and number of layers used in the hidden layer depends on the problem that is to be solved by the neural network.

As illustrated in FIG. 1, the neurons of the input layer are coupled to the neurons of the first hidden layer h₁. The neurons of the input layer pass the un-modified input data values at their inputs, Input₁-Inputₖ, to the inputs of the neurons of the first hidden layer h₁. The input of each neuron in the first hidden layer h₁ is therefore coupled to one or more neurons in the input layer, and the output of each neuron in the first hidden layer h₁ is coupled to the input of one or more neurons in the second hidden layer h₂. Likewise, the input of each neuron in the second hidden layer h₂ is coupled to the output of one or more neurons in the first hidden layer h₁, and the output of each neuron in the second hidden layer h₂ is coupled to the input of one or more neurons in the third hidden layer h₃. The input of each neuron in the third hidden layer h₃ is therefore coupled to the output of one or more neurons in the second hidden layer h₂, and the output of each neuron in the third hidden layer h₃ is coupled to one or more neurons in the output layer.

FIG. 2 illustrates a schematic diagram of a neuron. The example neuron illustrated in FIG. 2 may be used to provide the neurons in hidden layers h₁-h₃ of FIG. 1, as well as the neurons in the output layer of FIG. 1. As mentioned above, the neurons of the input layer typically pass the un-modified input data values at their inputs, Input₁-Inputₖ, to the inputs of the neurons of the first hidden layer h₁. The example neuron in FIG. 2 includes a summing portion labelled with a sigma symbol, and an activation function labelled with an S-shaped symbol. In operation, data inputs I₀-Iⱼ₋₁ are weighted by corresponding weights w₀-wⱼ₋₁ and summed, together with the weighted bias value B, which is weighted by weight wⱼ, to provide an intermediate output value S. The weight wⱼ applied to bias value B is typically unity. The intermediate output value S is inputted to the activation function F(S) to generate neuron output Y. The activation function acts as a mathematical gate and determines how strongly the neuron should be activated at its output Y based on its input value S. The activation function typically also normalizes its output Y, for example to a value of between 0 and 1, or between −1 and +1. Various activation functions may be used, such as a Sigmoid function, a Tanh function, a step function, Rectified Linear Unit “ReLU”, Softmax and Swish function.

Variations of the example Feed Forward Deep neural network described above with reference to FIG. 1 and FIG. 2 that are used in other types of neural networks may for instance include the use of different numbers of neurons, different numbers of layers, different connectivity between the neurons and the layers, and the use of layers and/or neurons with different functions to that exemplified above with reference to FIG. 1 and FIG. 2. For example, a convolutional neural network includes additional filter layers, and a recurrent neural network includes neurons that send feedback signals to each other. However, as described above, a feature common to neural networks is that they include multiple “neurons”, which are the basic unit of a neural network.

As outlined above, the process of training a neural network includes automatically adjusting the above-described weights that connect the neurons in the neural network, as well as the biases of activation functions controlling the outputs of the neurons. In supervised learning, the neural network is presented with (training) input data that has a known classification. The input data might for instance include images of animals that have been classified with an animal “type”, such as cat, dog, horse, etc. In supervised learning, the training process automatically adjusts the weights and the biases, such that when presented with the input data, the neural network accurately provides the corresponding output data. The neural network may for example be presented with a variety of images corresponding to each class. The neural network analyses each image and predicts its classification. A difference between the predicted classification and the known classification, is used to “backpropagate” adjustments to the weights and biases in the neural network such that the predicted classification is closer to the known classification. The adjustments are made by starting from the output layer and working backwards in the network until the input layer is reached. In the first training iteration the initial weights and biases, of the neurons are often randomized. The neural network then predicts the classification, which is essentially random. Backpropagation is then used to adjust the weights and the biases. The teaching process is terminated when the difference, or error, between the predicted classification and the known classification is within an acceptable range for the training data. In a later deployment phase, the trained neural network is presented with new images without any classification. If the training process was successful, the trained neural network accurately predicts the classification of the new images.

Various algorithms are known for use in the backpropagation stage of training. Algorithms such as Stochastic Gradient Descent “SGD”, Momentum, Adam, Nadam, Adagrad, Adadelta, RMSProp, and Adamax “optimizers” have been developed specifically for this purpose. Essentially, the value of a loss function, such as the mean squared error, or the Huber loss, or the cross entropy, is determined based on a difference between the predicted classification and the known classification. The backpropagation algorithm uses the value of this loss function to adjust the weights and biases. In SGD, for example, the derivative of the loss function with respect to each weight is computed using the activation function and this is used to adjust each weight.

With reference to FIG. 1 and FIG. 2, therefore, training the neural network in FIG. 1 includes adjusting the weights w₀-wⱼ₋₁ that represent the weights, and wⱼ that controls the bias value applied to the exemplary neuron of FIG. 2, for the neurons in the hidden layers h₁-h₃ and in the output layer. The training process is computationally complex and therefore cloud-based, or server-based, or mainframe-based processing systems that employ dedicated neural processors are typically employed. During training of the neural network in FIG. 1, the parameters of the neural network, or more specifically the weights and the biases, are adjusted via the aforementioned backpropagation procedure such that a difference between the known classification and the classification generated at Output₁-Outputₙ of the neural network in response to inputting training data to the student neural network, satisfies a stopping criterion. In other words, the training process is used to optimise the parameters of the neural network, or more specifically the weights and the biases. In supervised learning, the stopping criterion is that the difference between the output data generated at Output₁-Outputₙ, and the label(s) of the input data is within a predetermined margin. For example, if the input data includes images of cats, and that a definite classification of a cat is represented by a probability value of unity at Output 1, the stopping criterion might be that the for each input cat image the neural network generates a value of greater than 75% at Output 1. In unsupervised learning, a stopping criterion might be that a self-generated classification that determined by the neural network itself based on commonalities in the input data, likewise generates a value of greater than 75% at Output 1. Alternative stopping criteria may also be used in a similar manner during training.

After a neural network such as that described with reference to FIG. 1 and FIG. 2 has been trained, new data is input to the neural network. The new input data is then classified or other predictions are made thereupon by the neural network in accordance with its functionality. The processing requirements of processing the new input data are significantly less than those required during training. This allows the neural network to be deployed onto a variety of systems such as laptop computers, tablets, mobile phones and so forth. In order to alleviate the processing requirements of the system on which the neural network is deployed, further optimisation techniques may also be carried out by the processing system that performs the training, prior to its deployment. Such techniques make further changes to the parameters of the neural network in order to optimise its performance, and include a process termed compression.

Compression is defined herein as pruning and/or weight clustering and/or quantisation, and is carried out prior to deploying a neural network. Pruning a neural network is defined herein as the removal of one or more connections in a neural network. Pruning involves removing one or more neurons from the neural network, or removing one or more connections defined by the weights of the neural network. This may involve removing one or more of its weights entirely, or setting one or more of its weights to zero. Pruning permits a neural network to be processed faster due to the reduced number of connections, or due to the reduced computation time involved in processing zero value weights. Quantisation of a neural network involves reducing a precision of one or more of its weights. Quantization may involve reducing the number of bits that are used to represent the weights—for example from 32 to 16, or changing the representation of the weights from floating point to fixed point. Quantization permits the quantized weights to be processed faster, or by a less complex processor. Weight clustering in a neural network involves identifying groups of shared weight values in the neural network and storing a common weight for each group of shared weight value. Weight clustering permits the weights to be stored with less bits, and reduces the storage requirements of the weights as well as the amount of data transferred when processing the weights. Each of the above-mentioned compression techniques act independently to accelerate or otherwise alleviate the processing requirements of the neural network. Examples techniques for pruning, quantization and weight clustering are described in a document by Han, Song et al. (2016) entitled “Deep Compression: Compressing Deep Neural Networks with Pruning, Trained Quantization and Huffman Coding”, arXiv:1510.00149v5, published as a conference paper at ICLR 2016.

In accordance with the present disclosure, a computer-implemented method of optimising a neural network, is provided. The method may for example be used to optimise the neural network described in relation to FIG. 1 and FIG. 2. A related computer program product and system are also disclosed. For the sake of brevity, the method is described in detail, and it is also to be appreciated that features described in relation to the method may also be used in a corresponding manner in the computer program product, or in the system.

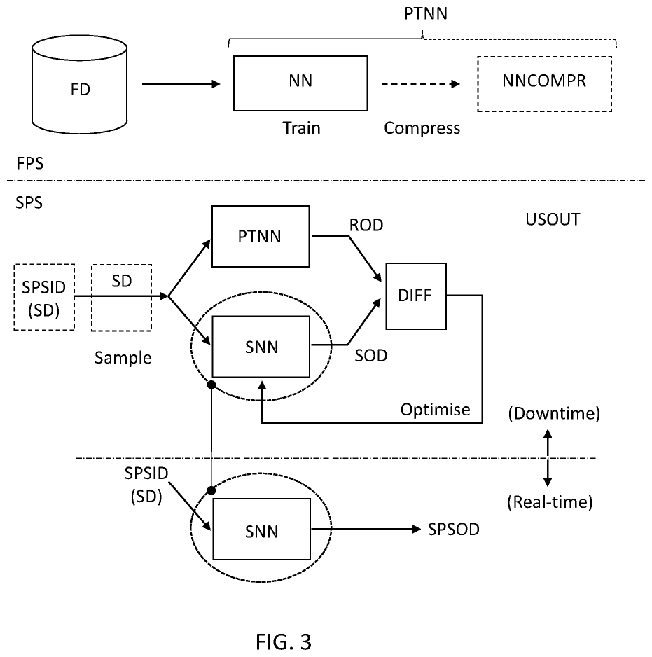

FIG. 3 is a schematic diagram that includes a second processing system SPS for optimising a student neural network SNN in accordance with some aspects of the disclosure. The upper portion of FIG. 3 illustrates a first processing system FPS that is used to train a neural network and thereby provide a previously-trained neural network PTNN. The previously-trained neural network PTNN is trained using first data FD. The lower portion of FIG. 3 illustrates a second processing system SPS that uses the previously-trained neural network PTNN, to optimise a student neural network SNN. The optimisation of the student neural network SNN is performed using second data SD, and uses the previously-trained neural network PTNN as a teacher. Optimising the student neural network SNN includes training the student neural network SNN and/or compressing the student neural network SNN. By performing the optimisation on the second processing system SPS, and also by performing the optimisation using the second data SD, the optimised student neural network that is the result of the optimisation, is tailored to both the processing capabilities of the second processing system SPS, as well as to the second data SD. This contrasts with using the same processing system and a single dataset for performing such optimisation.

With reference to FIG. 3, a computer-implemented method of optimising a student neural network SNN, based on a previously-trained neural network PTNN trained on first data FD using a first processing system FPS, includes: using a second processing system SPS to generate reference output data ROD from the previously-trained neural network PTNN in response to inputting second data SD to the previously-trained neural network PTNN; and optimising a student neural network SNN for processing the second data SD with the second processing system SPS, by using the second processing system SPS to adjust a plurality of parameters of the student neural network SNN such that a difference DIFF between the reference output data ROD, and second output data SOD generated by the student neural network SNN in response to inputting the second data SD to the student neural network SNN, satisfies a stopping criterion.

In more detail, first processing system FPS in FIG. 3 may be a cloud-based processing system or a server-based processing system or a mainframe-based processing system, and second processing system SPS may be an “on-device”-based processing system or a mobile device-based processing system such as a laptop computer, a tablet, a mobile phone, and so forth.

Referring to first processing system FPS in FIG. 3, first data FD is input to first processing system FPS in order to train a neural network NN. Neural network NN may be any type of neural network, such as the Deep Feed Forward neural network of FIG. 1, or a convolutional neural network, or a recurrent neural network and so forth, and neural network NN may be used to perform a variety of tasks, including for example prediction, regression and classification tasks. The training of neural network NN may for instance include supervised learning, unsupervised learning, or semi-supervised learning. The training process indicated by the label “Train” in FIG. 3 provides the previously-trained neural network PTNN. As indicated by the label “Compress” in FIG. 3, the previously-trained neural network PTNN may optionally be further compressed, to provide a compressed previously trained neural network NNCOMPR. Compression techniques such as pruning and/or weight clustering and/or quantisation may be used to provide compressed previously trained neural network NNCOMPR.

By way of an example, neural network NN in FIG. 3 may be an image classification neural network, wherein first data FD includes images of animals that are classified a priori with an animal type (e.g. cat, dog, horse, etc.). The training process indicated by the label Train in FIG. 3 results in a previously trained neural network PTNN that generates the a priori classification for each image in first data FD with high accuracy. If trained well, when previously-trained neural network PTNN is presented with new, as-yet unseen, images, it is also capable of correctly classifying the new images as one of the animal types.

Referring now to second processing system SPS in FIG. 3; the previously trained neural network PTNN, which may optionally have undergone the compression described above, is then transferred to the second processing system SPS. The second processing system may for example receive the previously trained neural network PTNN from a computer readable storage medium, which may for instance be in the “cloud”, or on a server. Previously trained neural network PTNN may therefore be received, or “downloaded” from the internet, the cloud, or from another computer-readable storage medium, and such downloading may be via wired or wireless connection.

Second processing system SPS in FIG. 3 also includes a student neural network SNN. The term “student” refers to the fact that the student neural network SNN will be optimised under the guidance of the previously-trained neural network PTNN, as described below. The previously-trained neural network PTNN may thus be considered to represent a teacher in the context of a teacher-student relationship with the student neural network SNN. Student neural network SNN may have the same architecture as the previously-trained neural network PTNN, or a different architecture. In some implementations, student neural network SNN is provided by compressing the previously-trained neural network PTNN. For example, student neural network SNN may be compressed by means of pruning and/or weight clustering and/or quantising previously-trained neural network PTNN. Such compression reduces the size and/or complexity of the student neural network, thereby reducing the complexity of optimising of the student neural network on the second processing system SPS.

With continued reference to second processing system SPS in FIG. 3, second data SD is input to the previously-trained neural network PTNN, and also to the student neural network SNN. Second data may be received by second processing system by various means. Second data SD may be transferred to second processing system SPS by means of wired or wireless communication as outlined above. Second data SD may be generated by a camera, a microphone or another input device in communication with second processing system SPS. The camera or microphone, together with the second processing system SPS may be disposed within a device, such as a mobile phone. The second data SD may therefore include images that are generated by the camera or audio data generated by the microphone. Second data SD represents different, i.e. non-identical data, to the first data FD that was used to train the previously-trained neural network PTNN. Continuing with the above animal image classification example, second data SD may include images of animals that are different images to those used to train previously-trained neural network PTNN.

With continued reference to second processing system SPS in FIG. 3; in response to inputting the second data SD to the previously-trained neural network PTNN, the previously-trained neural network PTNN generates reference output data ROD. Continuing with the above animal image classification example, output data ROD may include a plurality of animal classes, together with the probability that the second data belongs to that class. In other words, output data ROD may include: cat: 80%, dog: 5%, horse, 8%, and so forth.

As illustrated in FIG. 3, the second output data SOD is generated by the student neural network SNN in response to inputting the second data SD to the student neural network SNN. Using the above animal image classification example, the second output data SOD may likewise include a plurality of animal classes, together with the probability that the second data belongs to that class. In other words, output data SOD may include: cat: 60%, dog: 10%, horse, 15%, and so forth.

As illustrated by the label DIFF in FIG. 3, a difference between the reference output data ROD, and second output data SOD, is then computed. Various mathematical formulae are contemplated for use in computing difference DIFF. These include for example the Mean Squared Logarithmic Error Loss, the Mean Absolute Error Loss, the Binary Cross-Entropy Loss, the Hinge Loss, the Squared Hinge Loss for regression-type neural networks; and the Multi-Class Cross-Entropy Loss, the Sparse Multiclass Cross-Entropy Loss, Kullback Leibler Divergence Loss for classification-type neural networks having multiple output classes.

Student neural network SNN in FIG. 3 is then optimised for processing the second data SD with the second processing system SPS, by using the second processing system SPS to adjust a plurality of parameters of the student neural network SNN such that the difference DIFF between the reference output data ROD, and second output data SOD generated by the student neural network SNN in response to inputting the second data SD to the student neural network SNN, satisfies a stopping criterion.

As outlined in the following example implementations, the optimising can include training, and/or compressing the student neural network SNN. In general, the parameters that are adjusted during the optimising may include the training parameters and/or the hyperparameters. The actual parameters that are adjusted during the optimising, as well as the stopping criterion, both depend on how the student neural network SNN is optimised.

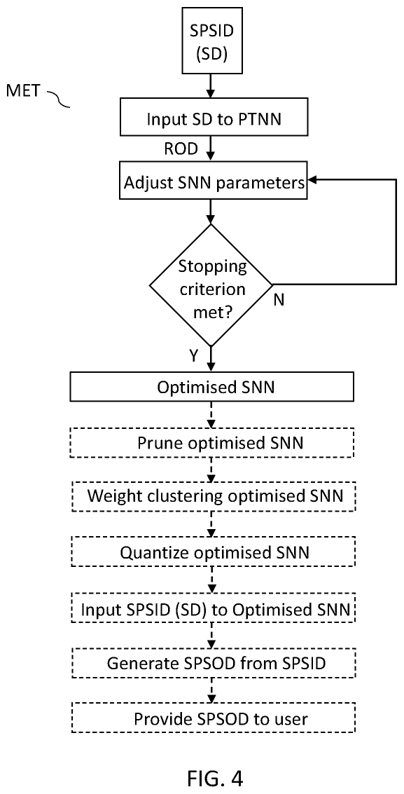

FIG. 4 is a flowchart illustrating a method MET of optimising a student neural network SNN in accordance with some aspects of the disclosure. Method MET may be used with second processing system SPS in FIG. 3. As described above in relation to FIG. 3, in the method MET, the second processing system SPS is used to generate reference output data ROD from the previously-trained neural network PTNN in response to inputting second data SD to the previously-trained neural network PTNN. The student neural network SNN is then optimised for processing the second data SD with the second processing system SPS, by using the second processing system SPS to adjust a plurality of parameters of the student neural network SNN such that a difference DIFF between the reference output data ROD, and second output data SOD generated by the student neural network SNN in response to inputting the second data SD to the student neural network SNN, satisfies a stopping criterion. When the stopping criterion is met, an optimised student neural network is provided as a result of adjusting the parameters of the student neural network SNN. Further optional aspects of the method indicated by way of the boxes with dashed outlines in FIG. 4 include pruning, quantizing, and weight clustering of the optimised student neural network SNN and are described later.

In one example implementation, the optimisation involves training the student neural network SNN. In this example implementation, with reference to FIG. 3 and the example neural network provided by FIG. 1 and FIG. 2, the plurality of parameters that are adjusted includes a plurality of weights w_{0 . . . j} connecting a plurality of neurons N_{0 . . . i} in the student neural network SNN, and a plurality of biases B of activation functions F(S) controlling outputs Y of the neurons N_{0 . . . i}. Optimising the student neural network SNN for processing the second data SD with the second processing system SPS, by using the second processing system SPS to adjust a plurality of parameters of the student neural network SNN such that a difference DIFF between the reference output data ROD, and second output data SOD generated by the student neural network SNN in response to inputting the second data SD to the student neural network SNN, satisfies a stopping criterion, comprises: iteratively adjusting the weights w_{0 . . . j} and the biases B of the student neural network SNN until the difference DIFF between the reference output data ROD, and the second output data SOD, is less than a predetermined value.

Thus, in this example implementation the parameters that are adjusted are the weights w_{0 . . . j} and the biases B. The stopping criterion is that difference DIFF between the reference output data ROD, and the second output data SOD, is less than a predetermined value. The adjusting may include the above-mentioned backpropagation process. By way of an example, the backpropagation may for instance use the above-mentioned SGD algorithm, wherein the derivative of the difference DIFF with respect to each weight is computed using the activation function and this is used to adjust each weight.

In so doing, the optimised student neural network that is provided by the iterative adjustments is tailored to both the processing capabilities of the second processing system, as well as to the second data. This alleviates the processing burden of operating the student neural network on the second processing system.

Optionally, in this example implementation, the iteratively adjusting the weights w_{0 . . . j} and the biases B of the student neural network SNN, may additionally include adjusting a temperature parameter of the student neural network SNN. In general, the temperature parameter of a neural network controls its classification confidence. When the student neural network is being trained, it may be beneficial to use the temperature parameter to soften the predictions of the previously-trained neural network PTNN, before they are used as targets for the student neural network SNN. In this example implementation the previously-trained neural network PTNN and the student neural network may generate class probabilities with logit vector Output where Output=(Output₁, . . . Outputₙ). A Softmax function may be performed in order to produce a probability vector q=(q₁, . . . qₙ) by comparing Output₁ with the other logits. Probability vector q is defined as:

$${q}_{i} = \frac{exp ( {Output}_{i} / T )}{{\sum }_{j} exp ( {Output}_{j} / T )} \qquad i . ( Equation 1 )$$

In general, the temperature parameter T in Equation 1 may be used to control the classification confidence of a neural network because it affects the sensitivity of the student neural network SNN to low probability output data candidates. Increasing the temperature parameter reduces the classification confidence.

Thus, in this example implementation, the previously-trained neural network PTNN is trained on the first data FD using a first value of a temperature parameter, the temperature parameter controlling a classification confidence of the previously-trained neural network PTNN. The: iteratively adjusting the weights w_{0 . . . j} and the biases B of the student neural network SNN until the difference between the reference output data ROD, and the second output data SOD, is less than a predetermined value, comprises: using a second value for the temperature parameter, the second value being higher than the first value such that a classification confidence of the optimised student neural network is lower than the classification confidence of the previously-trained neural network PTNN.

As illustrated by the dashed boxes in FIG. 4, after having optimised the student neural network SNN by means of training, in this example implementation, the optimised student neural network SNN may optionally undergo further optimisation in the form of compression. More specifically, the second processing system may be used to further optimise the optimised student neural network SNN by means of pruning and/or weight clustering and/or quantisation. Thus, in this example implementation, the student neural network comprises a plurality of neurons N_{0 . . . i}, and the second processing system SPS may be further used to: prune the optimised student neural network by removing one or more neurons N_{0 . . . i} from the optimised student neural network; and/or prune the optimised student neural network by removing one or more connections defined by the weights w_{0 . . . j} from the optimised student neural network; and/or quantize the optimised student neural network by reducing a precision of the weights w_{0 . . . j} of the optimised student neural network; and/or cluster the weights of the optimised student neural network.

Each of these processes further reduce the processing requirements of the second processing system.

In any of the above examples wherein the optimisation involves training the student neural network SNN, one or more hyperparameters of the student neural network SNN may also be adjusted during training in order to further optimise the training process.

In another example implementation, the optimisation described with reference to FIG. 3 involves compressing the student neural network SNN. In this example implementation the student neural network comprises a plurality of neurons N_{0 . . . i}, and the plurality of parameters comprises a plurality of weights w_{0 . . . j} connecting the plurality of neurons N_{0 . . . i} in the student neural network, and the: optimising a student neural network SNN for processing the second data SD with the second processing system SPS, by using the second processing system SPS to adjust a plurality of parameters of the student neural network SNN such that a difference between the reference output data ROD, and second output data SOD generated by the student neural network SNN in response to inputting the second data SD to the student neural network SNN, satisfies a stopping criterion, comprises: reducing a precision of the weights w_{0 . . . j} such that the difference between the reference output data ROD, and the second output data SOD, remains less than a predetermined limit; and/or: removing neurons N_{0 . . . i} and/or connections defined by the weights w_{0 . . . j} such that the difference between the reference output data ROD, and the second output data SOD, remains less than the predetermined limit.

Reducing a precision of the weights w_{0 . . . j}, and removing neurons N_{0 . . . i} and/or connections defined by the weights w_{0 . . . j}, both degrade the predictive accuracy of the student neural network SNN whilst simultaneously reducing the processing burden of running the optimised student neural network. This example implementation therefore allows a trade-off between predictive accuracy and processing burden to be made, and thereby tailored to, the second processing system SPS.

The value of the predetermined limit that is used when reducing a precision of the weights w_{0 . . . j}, or when removing neurons N_{0 . . . i} and/or connections defined by the weights w_{0 . . . j} therefore controls the accuracy with which the second output data SOD generated by the student neural network SNN predicts the reference output data ROD. Continuing with the above animal image classification example, the predetermined limit may be that the student neural network SNN should predict the classification generated by the previously-trained neural network to within a certain percentage. For example, images of cats that are inputted as second data SD may generate an output from the previously trained neural network PTNN with the classification of “cat” having 90% probability. The predetermined limit may be that images of cats, should generate an output from the student neural network SNN with the classification of “cat” as being within 10% of the 90% probability generated by the previously trained neural network PTNN; i.e. greater than 80%.

By using the second processing system SPS to perform each of these operations, and also by performing each of these operations with the second data SD, the optimised student neural network that is provided by each of these optimisation operations is tailored to both the processing capabilities of the second processing system SPS, as well as to the second data SD. This alleviates the processing burden of operating the optimised student neural network on the second processing system SPS.

Optionally, in some implementations the weights of the student neural network SNN are represented with a lower precision than the weights of the previously-trained neural network PTNN. This facilitates faster optimisation of the student neural network SNN. In these implementations the plurality of parameters of the student neural network SNN includes a plurality of weights w_{0 . . . j} connecting a plurality of neurons N_{0 . . . i} in the student neural network SNN. The previously-trained neural network PTNN also comprises a plurality of weights connecting a plurality of neurons in the previously-trained neural network PTNN. The weights of the student neural network w_{0 . . . j} are represented with a lower precision than the weights of the previously-trained neural network PTNN.

Optionally, in some implementations the student neural network SNN is provided by performing a quantization process on the previously-trained neural network PTNN. The quantization process may for instance be performed by the first processing system FPS, or by the second processing system SPS, or by yet another processing system. In these implementations the quantization process includes providing the weights w_{0 . . . j} of the student neural network SNN by reducing a precision of the weights of the previously-trained neural network PTNN such that the weights of the student neural network SNN are represented with a lower precision than the weights of the previously-trained neural network PTNN.

Optionally, in some implementations the second processing system SPS is used to perform the quantization process on the previously-trained neural network PTNN so that weights of the student neural network w_{0 . . . j} are represented with a lower precision than the weights of the previously-trained neural network PTNN. In these implementations, the second processing system SPS is used to perform the quantization process on the previously-trained neural network PTNN to provide the student neural network SNN, prior to optimising the student neural network SNN for processing the second data SD with the second processing system SPS. Using the second processing system SPS to perform the quantization process on the previously-trained neural network PTNN, requires only a single neural network, specifically the previously-trained neural network PTNN, to be transferred to the second processing system.

Optionally, in some implementations, the second data SD that is used in the optimisation is provided by sampling a dataset, specifically second processing system input data SPSID, that is input to the second processing system SPS. The second processing system input data SPSID is sampled, and included in a subset of the sampled second processing system input data SPSID in order to provide the second data SD if it increases a diversity metric of the subset.

This is indicated in FIG. 3 by way of the optional boxes with dashed outlines, and wherein the label “Sample” indicates that second processing input data SPSID is sampled to provide second data SD. Second processing input data SPSID encompasses second data SD. Using the above-described animal image classification example, if second data represents images of animals, second processing input data SPSID is a larger dataset of images of animals. As with second data SD, second processing input data SPSID may for example be generated by a camera, a microphone, or another input device in communication with second processing system SPS. Second processing system input data SPSID represents different, i.e. non-identical data, to first data FD which was used to train the previously-trained neural network PTNN.

In more detail, the second processing system SPS, receives second processing system input data SPSID; and the second processing system SPS is used to identify a subset of the second processing system input data SPSID to use as the second data SD. Identifying a subset of the second processing system input data SPSID to use as the second data SD, comprises: sampling the second processing system input data SPSID, and including the sampled second processing system input data in the subset if the sampled second processing system input data increases a diversity metric of the subset.

By selecting the second data SD using the diversity metric it is avoided that the optimised student neural network SNN becomes over-optimised, i.e. too sensitive, to common features in the data that is used to optimise the student neural network SNN, at the expense of diminished sensitivity to less common features in the data. Using the above-described animal image classification example, if the optimisation being performed using the second data SD is training, then if the second data SD predominantly includes images of a particular type, such as horses, then the optimisation risks being highly sensitive to horses at the expense of poor sensitivity to cats. Using the diversity metric helps to prevent this situation by using data that is as different as possible to optimise the student neural network SNN.

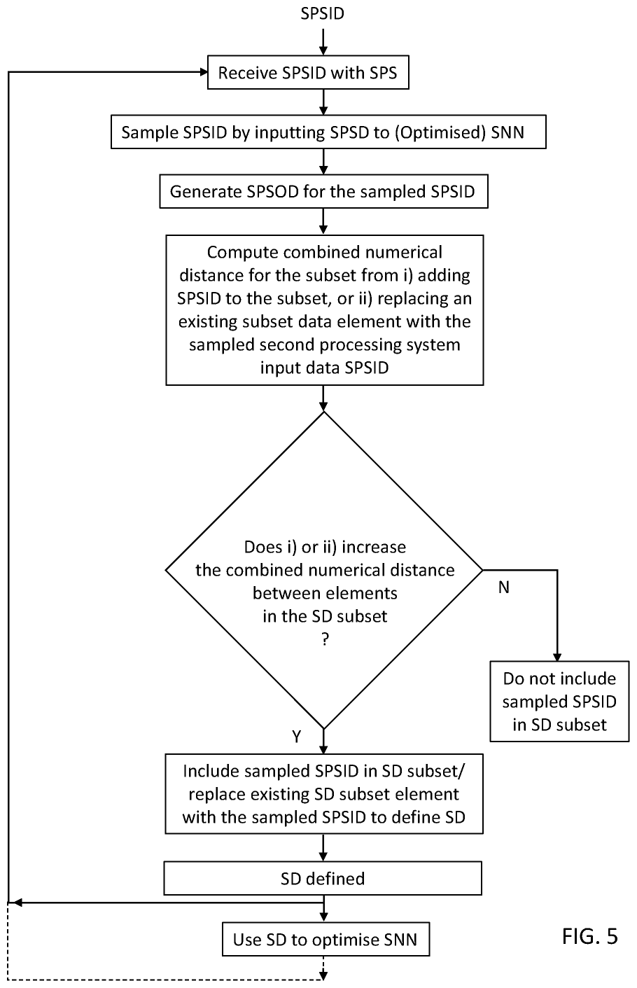

The diversity metric of the subset that is used to provide the second data SD may be computed in various ways. For example, the diversity metric may be computed based on a numerical distance between the output of the student neural network SNN, or the output of the previously-trained neural network PTNN, generated in response to inputting the sampled second processing system input data, and the output of the respective neural network, generated in response to inputting each existing element of the subset. This is illustrated in more detail with reference to FIG. 5, which is a flowchart illustrating a method of providing second data SD from second processing system input data SPSID in accordance with some aspects of the disclosure.

With reference to FIG. 5, the sampled second processing system input data SPSID, which may for example be an image, is received by the second processing system and input to a neural network, which may for example be the (optimised) student neural network, or the previously-trained neural network PTNN. A corresponding output from the (optimised) student neural network neural network is then provided as second processing system output data SPSOD. A numerical distance between second processing system output data SPSOD, and the (optimised) student neural network neural network output for each existing subset data element, is then computed. The numerical distances are then summed to provide a total numerical distance for the sampled second processing system input data SPSID. A combined numerical distance for the subset may then be computed by summing the individual total numerical distances for each existing subset data element. If adding the sampled second processing system input data SPSID to the subset increases the combined numerical distance, or if replacing an existing subset data element with the sampled second processing system input data SPSID, then the sampled second processing system input data SPSID is included in the subset. An existing subset data element may alternatively be replaced by the sampled second processing system input data SPSID, if the latter induces a higher total numerical distance.

The second data SD that is defined in this manner is then used to optimise the student neural network SNN. The second data SD in the subset may also be periodically updated. For example, if the subset has a fixed maximum size, such as 1000 images, then after including sufficient sampled second processing system input data SPSID to fill the subset, existing subset data elements may be replaced in order to further increase the diversity of the second data SD.

Various distance metrics may be used to compute the aforementioned numerical distance, including for example the Kullback-Leibler divergence “KLD”, the cosine distance “CD”, the Mean-Absolute Error “MAE”, the Mean-Squared Error “MSE”, the Minkowski Distance, the Euclidean Distance, and so forth.

Referring now to FIG. 3; in some implementations the second processing system SPS is used to generate second processing system output data SPSOD in response to inputting second processing system input data SPSID to the student neural network. The second data SD is a subset of the second processing system input data SPSID for use in optimising the student neural network SNN. The second processing system output data SPSOD may be provided to a user, and in some instances substantially in real-time, or in other words. “live”.

Optionally, in some implementations the second processing system output data SPSOD that is generated by the by neural network is provided to a user and substantially in real-time, and the optimising of the student neural network is performed at a later point in time. This option is indicated by way of the horizontal dashed line separating the labels “Down-time” and “Real-time” in FIG. 3. The down-time may for instance be when the second processing system is less active with generating live second processing system output data SPSOD, for example during the night time. In these implementations the second processing system output data SPSOD is provided to a user, and substantially in real-time, and the: optimising a student neural network SNN for processing the second data SD with the second processing system SPS, by using the second processing system SPS to adjust a plurality of parameters of the student neural network SNN such that a difference between the reference output data ROD, and second output data SOD generated by the student neural network SNN in response to inputting the second data SD to the student neural network SNN, satisfies a stopping criterion, is performed subsequently in time to the: using the second processing system SPS to generate second processing system output data SPSOD in response to inputting second processing system input data SPSID to the student neural network SNN.

Using the above-described animal image classification example, in these latter implementations, if second processing system input data SPSID represents images of animals, the second neural network may be used to generate second processing system output data SPSOD in the form of a classification of the animal images. The classification may be in real-time. After having performed the classification, the second processing system may use a subset of the second processing system input data SPSID, i.e. the second data SD, to optimise the student neural network SNN. The subset may be determined by sampling the second processing system input data SPSID, and including the sampled second processing system input data in the subset if the sampled second processing system input data increases a diversity metric of the subset. By performing the optimisation after the real-time classification, it is avoided that the optimisation interrupts the classification.

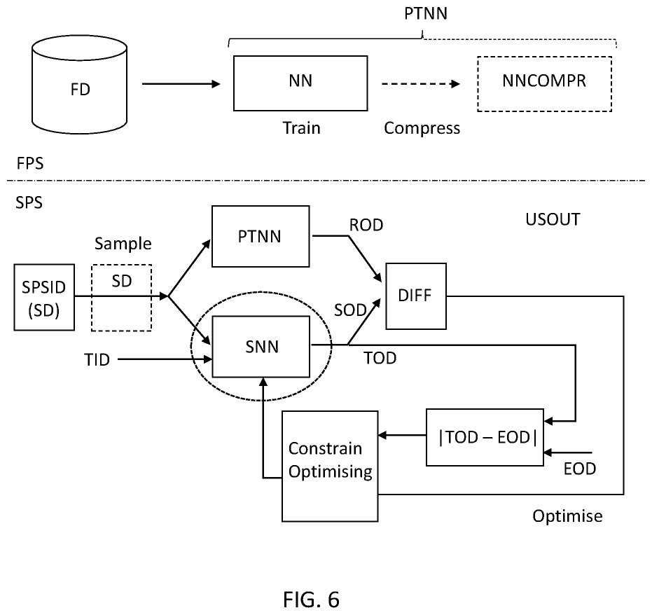

Optionally, in some implementations the optimisation of the student neural network is constrained in order to ensure that for particular test input data, the output of the optimised neural network does not diverge too far from corresponding expected output data. This acts to prevent the optimised student neural network from becoming too sensitive to some features of the input data at the expense of being insensitive to other features of the input data. Thereto, FIG. 6 is a schematic diagram that includes a second processing system SPS for optimising a student neural network SNN that includes the constraining of the optimising of the student neural network SNN in accordance with some aspects of the disclosure. Items in FIG. 6 correspond to similar-labelled items in FIG. 3. In addition to the items in FIG. 3, FIG. 6 includes test input data TID that is applied to student neural network SNN, test output data TOD that is generated by student neural network SNN in response to inputting test input data TID, expected output data EOD that is expected from the optimised student neural network in response to inputting the test input data to the optimised student neural network, a block |TOD−EOD| illustrating the determination of the modulus of the difference between the test output data TOD and the expected output data EOD. FIG. 6 also includes item “Constrain optimising” indicating that the optimising of the student neural network based on the difference DIFF that was described above with reference to FIG. 3, is constrained by the modulus of the difference between the test output data TOD and the expected output data EOD.

With reference to FIG. 6, in these implementations the second processing system SPS is used to generate test output data TOD from the optimised student neural network in response to test input data TID, the test input data TID having corresponding expected output data EOD that is expected from the optimised student neural network in response to inputting the test input data to the optimised student neural network. Moreover, the second processing system SPS is used to constrain the optimising of the student neural network SNN for processing the second data SD with the second processing system SPS, such that the difference between the generated test output data TOD, and the expected output data EOD, is less than a second predetermined value.

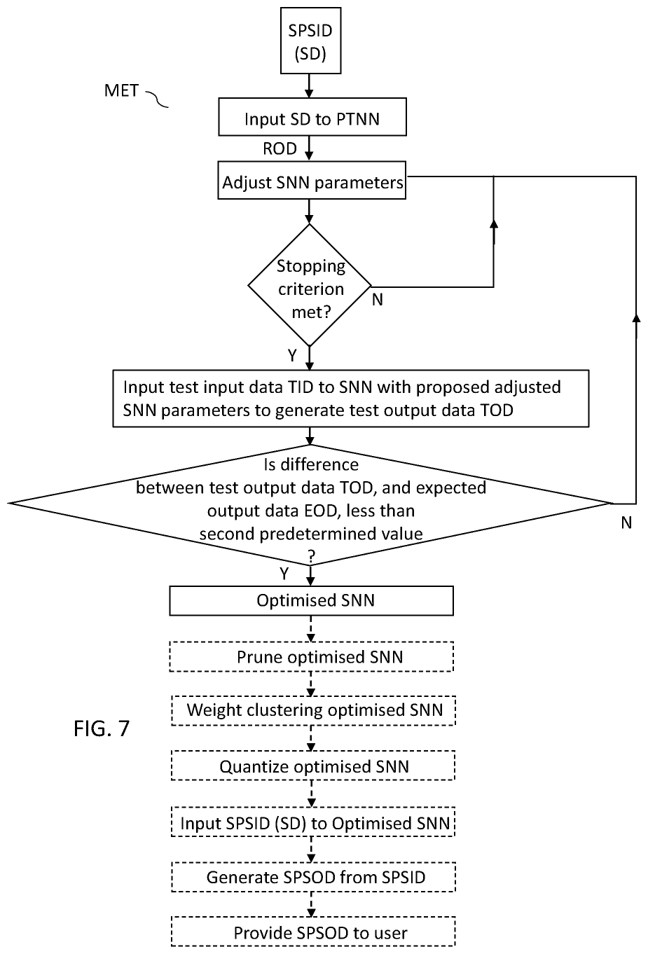

FIG. 7 is a flowchart illustrating a method of optimising a student neural network SNN that includes the constraining of the optimising of the student neural network SNN in accordance with some aspects of the disclosure. The flowchart of FIG. 7 corresponds to the use of the second processing system SPS described above with reference to FIG. 6. The flowchart of FIG. 7 corresponds to the flowchart of FIG. 4 up to and including the item “Stopping criterion met?”. Following from this point in FIG. 7, when the stopping criterion is met, the test input data TID is inputted to the student neural network SNN. The output of the student neural network, test output data TOD, is then computed for the test input data TID using the proposed adjusted parameters of the student neural network. A difference between the test output data TOD, and the expected output data EOD, is then computed and compared with a second predetermined value. A numerical distance, as described above, may be used to compute this difference. The second predetermined value may for instance represent a limit to the percentage variation between the test output data TOD, and the expected output data EOD. If the difference between the test output data TOD, and the expected output data EOD, is less than the second predetermined value, the adjusted parameters are used in the optimised student neural network, otherwise the student neural network parameters are again optimised until the stopping criterion is met, and the difference between the test output data TOD, and the expected output data EOD, is less than the predetermined value.

Using the above-described animal image classification example, test input data TID may for example include an image of a dog, a cat and a horse that are each classified with corresponding expected output data EOD indicative of the classification and its associated probability: “Dog, 100%”, “Cat, 100%”, “Horse, 100%”. If, using the proposed adjusted parameters, the student neural network SNN classifies each image by generating test output data TOD that is within less than a certain percentage, for example to within less than 20% of each of the above EOD classification probability values, then the proposed adjusted parameters are used in the optimised student neural network SNN. Otherwise, the optimisation described above is repeated.

The above-described methods may be provided on a non-transitory computer-readable storage medium comprising a set of computer-readable instructions stored thereon which, when executed by at least one processor, cause the at least one processor to perform the method. In other words, the above-described methods may be implemented as a computer program product. The computer program product can be provided by dedicated hardware or hardware capable of running the software in association with appropriate software. When provided by a processor, these functions can be provided by a single dedicated processor, a single shared processor, or multiple individual processors that some of the processors can share. Moreover, the explicit use of the terms “processor” or “controller” should not be interpreted as exclusively referring to hardware capable of running software, and can implicitly include, but is not limited to, digital signal processor “DSP” hardware, read only memory “ROM” for storing software, random access memory “RAM”, a non-volatile storage device, and the like. Furthermore, implementations of the present disclosure can take the form of a computer program product accessible from a computer usable storage medium or a computer readable storage medium, the computer program product providing program code for use by or in connection with a computer or any instruction execution system. For the purposes of this description, a computer-usable storage medium or computer-readable storage medium can be any apparatus that can comprise, store, communicate, propagate, or transport a program for use by or in connection with an instruction execution system, apparatus, or device. The medium can be an electronic, magnetic, optical, electromagnetic, infrared, or semiconductor system or device or device or propagation medium. Examples of computer readable media include semiconductor or solid state memories, magnetic tape, removable computer disks, random access memory “RAM”, read only memory “ROM”, rigid magnetic disks, and optical disks. Current examples of optical disks include compact disk-read only memory “CD-ROM”, optical disk-read/write “CD-R/W”, Blu-Ray™, and DVD.

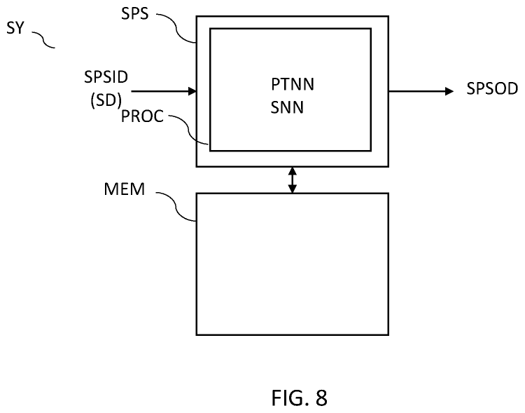

A system is also provided for execution of the above-described method. Thereto, FIG. 8 illustrates a system SY for optimising a student neural network SNN that includes a processor in the form of second processing system SPS, and a memory MEM. The functionality and features of the second processing system SPS in FIG. 8 are described above and not duplicated here. In some implementations, system SY may be a mobile device such as a laptop computer, or a tablet, or a mobile phone, or a “Smart appliance” such as a smart doorbell, a smart fridge, a home assistant, a security camera, or an “Internet of Things” device such as a sound detector, or a vibration detector, or an atmospheric sensors, or an “Autonomous device” such as a vehicle, or a drone, or a robot. The system SY is suitable for optimising a student neural network SNN, based on a previously-trained neural network PTNN trained on first data FD using a first processing system FPS. The system SY includes: a second processing system SPS comprising one or more processors PROC; a memory MEM in communication with the one or more processors PROC of the second processing system SPS, the memory comprising instructions, which when executed by the one or more processors PROC of the second processing system SPS, cause the second processing system SPS to: use the second processing system SPS to generate reference output data ROD from the previously-trained neural network PTNN in response to inputting second data SD to the previously-trained neural network PTNN; and to optimise a student neural network SNN for processing the second data SD with the second processing system SPS, by using the second processing system SPS to adjust a plurality of parameters of the student neural network SNN such that a difference between the reference output data ROD, and second output data SOD generated by the student neural network SNN in response to inputting the second data SD to the student neural network SNN, satisfies a stopping criterion.

In use, previously-trained neural network PTNN, and student neural network SNN are transferred to second processing system SPS. These neural networks may for instance be transferred to second processing system SPS by transferring the parameters and configuration settings that define their architecture and control their operation. The neural networks may be transferred by reading data from a computer-readable storage medium, or downloaded from the Internet or the Cloud. System SY may optionally include a camera or another type of input device for receiving or generating second processing system input data SPSID. System SY may for instance include an input device in the form of a microphone for configured to generate audio data. The use of other input devices configured to sense or receive other types of data, including optical, vibration, pressure, temperature, motion is also contemplated. Second processing system input data SPSID may alternatively be read from an external computer readable storage medium. System SY may also include an output device such as a display or a speaker (not illustrated in FIG. 8) for providing second processing system output data SPSOD to a user.

The above example implementations are to be understood as illustrative examples of the present disclosure. Further implementations are also envisaged. For example, the implementations described in relation to a method may also be implemented in the computer program product, in the computer readable storage medium, or in the system. It is therefore to be understood that a feature described in relation to any one implementation may be used alone, or in combination with other features described, and may also be used in combination with one or more features of another of the implementation, or a combination of other the implementations. Furthermore, equivalents and modifications not described above may also be employed without departing from the scope of the disclosure, which is defined in the accompanying claims. Any reference signs in the claims should not be construed as limiting the scope of the disclosure.

What is claimed is:

1. A computer-implemented method of optimising a student neural network (SNN), based on a previously-trained neural network (PTNN) trained on first data (FD) using a first processing system (FPS), the method comprising:
using a second processing system (SPS) to generate reference output data (ROD) from the previously-trained neural network (PTNN) in response to inputting second data (SD) to the previously-trained neural network (PTNN); and
optimising a student neural network (SNN) for processing the second data (SD) with the second processing system (SPS), by using the second processing system (SPS) to adjust a plurality of parameters of the student neural network (SNN) such that a difference (DIFF) between the reference output data (ROD), and second output data (SOD) generated by the student neural network (SNN) in response to inputting the second data (SD) to the student neural network (SNN), satisfies a stopping criterion.

2. The computer-implemented method according to claim 1, further comprising: receiving, with the second processing system (SPS), second processing system input data (SPSID); and
using the second processing system (SPS) to identify a subset of the second processing system input data (SPSID) to use as the second data (SD); and wherein: identifying a subset of the second processing system input data (SPSID) to use as the second data (SD), comprises:
sampling the second processing system input data (SPSID), and including the sampled second processing system input data in the subset if the sampled second processing system input data increases a diversity metric of the subset.

3. The computer-implemented method according to claim 1, wherein the plurality of parameters comprises a plurality of weights (w_{0 . . . j}) connecting a plurality of neurons (N_{0 . . . i}) in the student neural network (SNN), and a plurality of biases (B) of activation functions (F(S)) controlling outputs (Y) of the neurons (N_{0 . . . i}), and wherein the: optimising a student neural network (SNN) for processing the second data (SD) with the second processing system (SPS), by using the second processing system (SPS) to adjust a plurality of parameters of the student neural network (SNN) such that a difference (DIFF) between the reference output data (ROD), and second output data (SOD) generated by the student neural network (SNN) in response to inputting the second data (SD) to the student neural network (SNN), satisfies a stopping criterion, comprises:
iteratively adjusting the weights (w_{0 . . . j}) and the biases (B) of the student neural network (SNN) until the difference (DIFF) between the reference output data (ROD), and the second output data (SOD), is less than a predetermined value.

4. The computer-implemented method according to claim 3, wherein the previously-trained neural network (PTNN) is trained on the first data using a first value of a temperature parameter, the temperature parameter controlling a classification confidence of the previously-trained neural network (PTNN), and wherein the: iteratively adjusting the weights (w0 . . . j) and the biases (B) of the student neural network (SNN) until the difference between the reference output data (ROD), and the second output data (SOD), is less than a predetermined value, comprises:
using a second value for the temperature parameter, the second value being higher than the first value such that a classification confidence of the optimised student neural network is lower than the classification confidence of the previously-trained neural network (PTNN).

5. The computer-implemented method according to claim 3, wherein the student neural network comprises the plurality of neurons (N_{0 . . . i}), and further comprising:
using the second processing system (SPS) to prune the optimised student neural network by removing one or more neurons (N_{0 . . . i}) from the optimised student neural network; and/or
using the second processing system (SPS) to prune the optimised student neural network by removing one or more connections defined by the weights (w_{0 . . . j}) from the optimised student neural network; and/or
using the second processing system (SPS) to quantize the optimised student neural network by reducing a precision of the weights (w_{0 . . . j}) of the optimised student neural network; and/or
using the second processing system (SPS) to cluster the weights of the optimised student neural network.

6. The computer-implemented method according to claim 1, wherein the student neural network comprises a plurality of neurons (N_{0 . . . i}), and wherein the plurality of parameters comprises a plurality of weights (w_{0 . . . j}) connecting the plurality of neurons (N_{0 . . . i}) in the student neural network, and wherein the: optimising a student neural network (SNN) for processing the second data (SD) with the second processing system (SPS), by using the second processing system (SPS) to adjust a plurality of parameters of the student neural network (SNN) such that a difference between the reference output data (ROD), and second output data (SOD) generated by the student neural network (SNN) in response to inputting the second data (SD) to the student neural network (SNN), satisfies a stopping criterion, comprises:
reducing a precision of the weights (w_{0 . . . j}) such that the difference between the reference output data (ROD), and the second output data (SOD), remains less than a predetermined limit; and/or:
removing neurons (N_{0 . . . i}) and/or connections defined by the weights (w_{0 . . . j}) such that the difference between the reference output data (ROD), and the second output data (SOD), remains less than the predetermined limit.

7. The computer-implemented method according to claim 1, wherein the plurality of parameters comprises a plurality of weights (w_{0 . . . j}) connecting a plurality of neurons (N_{0 . . . i}) in the student neural network (SNN); and wherein the previously-trained neural network (PTNN) comprises a plurality of weights connecting a plurality of neurons in the previously-trained neural network (PTNN), and wherein the weights of the student neural network (w_{0 . . . j}) are represented with a lower precision than the weights of the previously-trained neural network (PTNN).

8. The computer-implemented method according to claim 7, wherein the student neural network (SNN) is provided by performing a quantization process on the previously-trained neural network (PTNN), and wherein the quantization process comprises providing the weights (w_{0 . . . j}) of the student neural network (SNN) by reducing a precision of the weights of the previously-trained neural network (PTNN) such that the weights of the student neural network (SNN) are represented with a lower precision than the weights of the previously-trained neural network (PTNN).

9. The computer-implemented method according to claim 8, further comprising: using the second processing system (SPS) to perform the quantization process on the previously-trained neural network (PTNN) to provide the student neural network (SNN), prior to optimising the student neural network (SNN) for processing the second data (SD) with the second processing system (SPS).

10. The computer-implemented method according to claim 1, further comprising:
using the second processing system (SPS) to generate second processing system output data (SPSOD) in response to inputting second processing system input data (SPSID) to the student neural network; and wherein the second data (SD) is a subset of the second processing system input data (SPSID) for use in optimising the student neural network (SNN).

11. The computer-implemented method according to claim 10, wherein the second processing system output data (SPSOD) is provided to a user, and substantially in real-time, and wherein the: optimising a student neural network (SNN) for processing the second data (SD) with the second processing system (SPS), by using the second processing system (SPS) to adjust a plurality of parameters of the student neural network (SNN) such that a difference between the reference output data (ROD), and second output data (SOD) generated by the student neural network (SNN) in response to inputting the second data (SD) to the student neural network (SNN), satisfies a stopping criterion,
is performed subsequently in time to the:
using the second processing system (SPS) to generate second processing system output data (SPSOD) in response to inputting second processing system input data (SPSID) to the student neural network (SNN).

12. The computer-implemented method according to claim 1, further comprising:
using the second processing system to generate test output data (TOD) from the student neural network in response to test input data (TID), the test input data (TID) having corresponding expected output data (EOD) that is expected from the student neural network in response to inputting the test input data to the student neural network; and further comprising:
constraining the optimising a student neural network (SNN) for processing the second data (SD) with the second processing system (SPS), such that a difference between the generated test output data (TOD), and the expected output data (EOD), is less than a second predetermined value.

13. The computer-implemented method according to claim 1, wherein the first processing system (FPS) is a cloud-based processing system or a server-based processing system or a mainframe-based processing system, and/or wherein the second processing system (SPS) is an on-device-based processing system or a mobile device-based processing system.

14. A computer program product comprising instructions which when executed on a processor cause the processor to carry out the method according to claim 1.

15. A system (SY) for optimising a student neural network (SNN), based on a previously-trained neural network (PTNN) trained on first data (FD) using a first processing system (FPS), the system (SY) comprising:
a second processing system (SPS) comprising one or more processors (PROC);
a memory (MEM) in communication with the one or more processors (PROC) of the second processing system (SPS), the memory comprising instructions, which when executed by the one or more processors (PROC) of the second processing system (SPS), cause the second processing system (SPS) to:
use the second processing system (SPS) to generate reference output data (ROD) from the previously-trained neural network (PTNN) in response to inputting second data (SD) to the previously-trained neural network (PTNN); and to
optimise a student neural network (SNN) for processing the second data (SD) with the second processing system (SPS), by using the second processing system (SPS) to adjust a plurality of parameters of the student neural network (SNN) such that a difference between the reference output data (ROD), and second output data (SOD) generated by the student neural network (SNN) in response to inputting the second data (SD) to the student neural network (SNN), satisfies a stopping criterion.
